(19) United States
(12) Patent Application Publication
(10) Pub. No.: US 2004/0267910 A1
(43) Pub. Date: Dec. 30, 2004

(54) Single-point management system for devices in a cluster

(75) Inventors: Basil Treppa, Santa Clara, CA (US); Ajay Mittal, Foster City, CA (US); Srikanth Koneru, Santa Clara, CA (US); Laura Xu, Sunnyvale, CA (US); Ajay Matai, Sunnyvale, CA (US)

Correspondence Address: MERCHANT & GOULD PC, P.O. BOX 2903, MINNEAPOLIS, MN, 55402-0903, US

(73) Assignee: NOKIA INC., Irving, TX

(21) Appl. No.: 10/603,925

(22) Filed: Jun. 24, 2003

(51) Int. Cl. G06F 15/177

(52) U.S. Cl. 709/220

(57) ABSTRACT

The present invention provides cluster management from a single application. A user may perform management tasks on all of the devices within the cluster using a GUI or a CLI. The system automatically discovers the members of the cluster and acquires a configuration lock on the devices preventing other users from performing conflicting operations. If a problem occurs during a configuration, the devices may be rolled back to a previous working configuration. A message format is provided to help ensure message integrity beyond the security provided by a secure transport. An aggregator aggregates configuration information and motored data and allows the information to be presented according to a user's requirements.

### BACKGROUND OF THE INVENTION

Equipment that provides a high degree of reliability is a prime consideration of organizations that supply Internet and Intranet services. To help meet this need, technology has become available to combine several devices into a cluster that is configured to act as a single device. Using the cluster arrangement, it is intended that the failure of one device does not significantly affect the remaining components within the cluster.

Clusters are configured to provide many services. For example, clusters are configured to perform traffic management, Domain Name System services, user authentication, authorization and accounting (AAA) services and collection of operational statistics. These types of services are generally known as Network Management (NM) services. The process of configuring these Network Management services within the cluster is known as Cluster Management.

In a typical single-device system, the operation of the NM services is governed by a set of attributes known as the NM configuration. In addition, the operation of the device is monitored by a set of information collected during the system's operation known as ‘NM monitored data’. The Network Management system allows the viewing of the configuration and monitored data and manipulation of the configuration in several ways, including through a Graphical User Interface (GUI), a Command Line Interface (CLI) and via the Simple Network Management Protocol (SNMP). Configuring the devices within the cluster is difficult and error prone.

One problem is that it is difficult to maintain identical configurations of the Network Management features on all devices within the cluster. In addition, errors in the configuration of one device, or incompatible configurations among the devices, may render a particular NM feature inoperable.

Another problem is that it is often difficult to integrate NM monitored data from multiple devices. This is especially true in cases where each datum has an associated timestamp.

Additionally, many systems do not provide a secure transport mechanism for device-to-device communication.

What is needed is a way to effectively configure and monitor a cluster.

### SUMMARY OF THE INVENTION

The present invention is directed at providing a Cluster Management (CM) system that allows the configuration and monitoring of a cluster from a single application.

According to one aspect of the invention, a user may perform management tasks on all of the devices within the cluster from a single application. The management may be performed using a GUI or a CLI.

According to another aspect of the invention, the system automatically discovers the members of the cluster and acquires a configuration lock on the devices preventing other users from performing conflicting operations.

According to yet another aspect of the invention, changes are tracked during a configuration of the cluster. If a problem occurs during a configuration, the devices may be ‘rolled back’ to a previous working configuration. The rollback feature helps to ensure the integrity of the configurations.

According to still yet another aspect of the invention, a message format is provided to help ensure message integrity beyond the security provided by a secure transport.

According to another aspect of the invention, an aggregator aggregates configuration information and monitored data and allows the information to be presented according to a user's requirements.

### BRIEF DESCRIPTION OF THE DRAWINGS

FIG. 1 illustrates a single-device Network Management system that may be used within a cluster;

FIG. 2 shows an exemplary architecture of a Cluster Management System (CMS);

FIG. 3 illustrates components of the Remote Management Broker;

FIG. 4 shows an exemplary Remote Management Broker message;

FIG. 5 illustrates a process flow for utilizing a cluster management system; and

FIG. 6 illustrates an exemplary node that may be used within the cluster;

FIG. 7 illustrates an exemplary environment in which the present invention may operate, in accordance with aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise.

The term “IP” means any type of Internet Protocol. The term “node” means a device that implements IP. The term “router” means a node that forwards IP packets not explicitly addressed to itself. The term “routable address” means an identifier for an interface such that a packet is sent to the interface identified by that address. The term “link” means a communication facility or medium over which nodes can communicate. The term “cluster” refers to a group of nodes configured to act as a single node.

The following abbreviations are used throughout the specification and claims: CCLI=Cluster Command Line Interface; CGUI=Cluster Graphical User Interface; CLI=Command Line Interface; CM=Cluster Management; GUI Graphical User Interface; MAC=Message Authentication Code; NM=Network Management; and RMB=Remote Management Broker.

Referring to the drawings, like numbers indicate like parts throughout the views. Additionally, a reference to the singular includes a reference to the plural unless otherwise stated or is inconsistent with the disclosure herein.

The present invention is directed at providing a Cluster Management (CM) system that allows the configuration and monitoring of a cluster from a single GUI or CLI. The system is used to manage NM attributes of devices within a cluster. According to one embodiment, any device within the cluster may be used to manage the cluster.

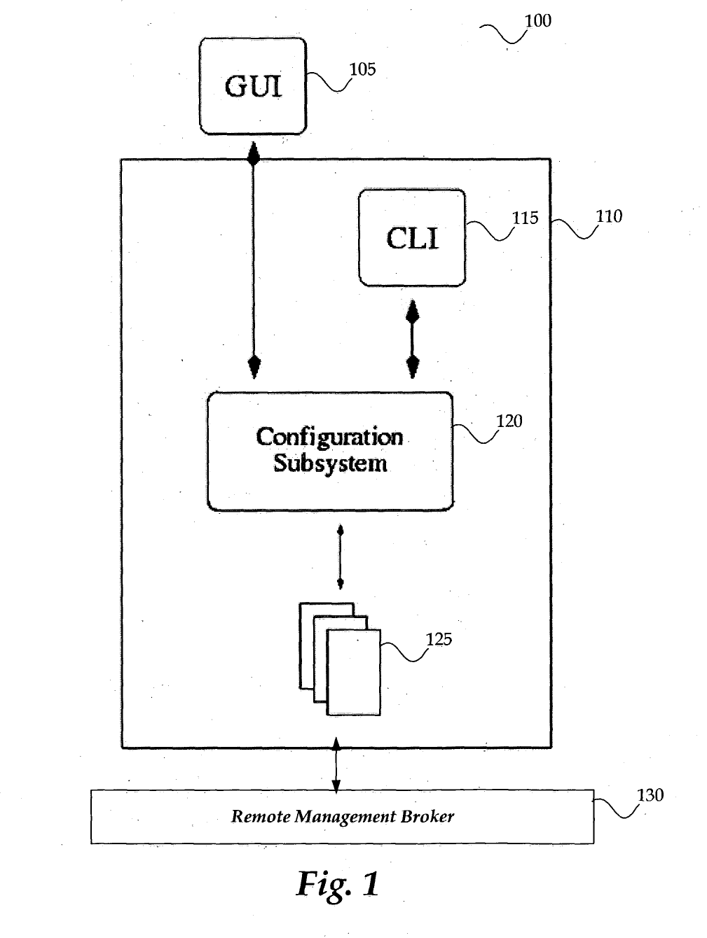

FIG. 1 illustrates a Network Management system for a single-device that may be used within a cluster, in accordance with aspects of the invention. As illustrated in the figure, NM system 100 includes GUI 105, device 110, and Remote Management Broker 130. Device 110 includes CLI 115, configuration subsystem 120, and attributes 125.

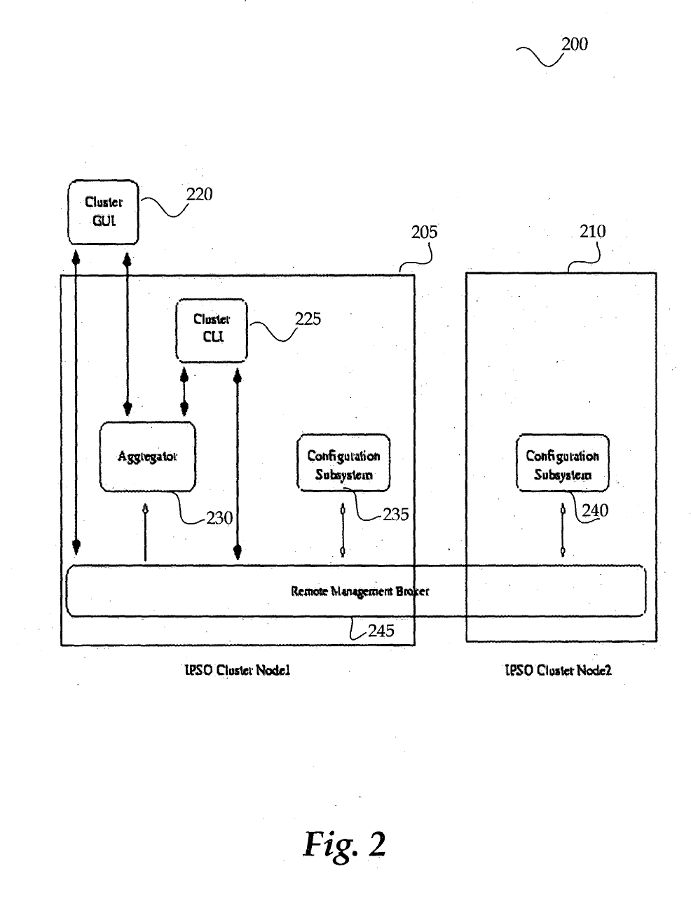

According to one embodiment, GUI 105 is configured to execute on a workstation (not shown) and interact with Configuration Subsystem 120 of device 110. GUI 105 provides a graphical interface to view NM configurations and perform NM operations for device 110. CLI 115 provides a command line interface that allows the user to view NM configurations and perform NM operations same on device 110 by an application executing on device 110. The GUI and CLI associated with device 110 may also be used to manage a cluster, as illustrated in FIG. 2.

Remote Management Broker (RMB) 130 is configured to communicate with other devices within the cluster. RMB 130 may be included within device 110 or it may be separate from device 110. Generally, RMB 130 communicates information relating to NM operations to the other nodes within the cluster.

FIG. 2 shows an exemplary architecture of a Cluster Management System (CMS), in accordance with aspects of the invention. As shown in the figure, CMS 200 includes Cluster GUI 220, Cluster CLI 225, Aggregator 230, Configuration Subsystems 235 and 240, and Remote Management Broker 245.

The GUI and CLI present a view of a single device and the Remote Management Broker provides the mechanisms to ensure integrity of the NM configuration on every device within the cluster. Generally, Cluster GQUl 220 and Cluster CLI 225 provide the same activities as GUI 105 and CLI 115 in the single-device NMS, as illustrated in FIG. 1, but are configured to perform those activities on all members of the cluster by interacting with Remote Management Broker 245. Cluster GUI 220 and Cluster CLI 225 can also be configured to perform NM information aggregation by interacting with Aggregator 230. Remote Management Broker 245 distributes information between the nodes within the cluster. According to one embodiment of the invention, each node is configured identically. In the present illustration, for example, node 210 and node 205 are configured identically.

According to one embodiment, the system acquires exclusive authority of the nodes within the cluster by applying a configuration lock before NM operations are performed. If the system cannot obtain the configuration lock, either because of system failure or activity of other NM applications, then the system does not allow the user to perform the operations. According to another embodiment, when the configuration lock is not obtained the user is presented with an opportunity to override the default.

Cluster GUI 220 is a management GUI that is responsible for graphically presenting the configuration and monitored data from the devices within a cluster. CGUI 220 is accessed by a user which establishes a connection with a node within the cluster. At initial contact the CGUI presents a page to the user where a user name and password are entered to perform the login process. According to one embodiment of the invention, the user name is used to determine whether a user is logging on to a single node or is logging on to perform operations to the cluster. For example, a special user, a ‘cluster administrator’, may be defined who is given the authority to perform Network Management tasks on all members of the cluster. This administrator can be the determining factor as to when operations are cluster-wide. For example, logging in as cluster administrator signals the system that cluster-wide operations are to be performed. According to one embodiment, this cluster administrator definition resides on every member of the cluster.

Assuming the user is accessing the cluster, then, when the login is completed CGUI 220 applies a configuration lock on all of the devices within the cluster and displays an information page indicating the cluster's members and some relevant information about each one. The information includes identifying information for the node and cluster, as well as other information relevant to the operation. The configuration lock is intended to prevent other applications from performing NM operations on the locked devices within the cluster while the user is logged-in.

According to one embodiment, the configuration lock is disabled after a pre-determined amount of inactive time. This helps to ensure that the cluster is not accidentally left locked. Various GUI elements can then be used to perform the desired NM operations.

According to one embodiment, CGUI 220 is implemented as a set of Web pages in a browser and a Web Server operating on a cluster member. The server may operate on all or some of the cluster members. The server delivers HTML pages to the browser in response to browser GET requests and receives POST requests to alter NM attributes associated with the nodes in the cluster.

Cluster CLI 225 is a management CLI that presents the NM information of the cluster textually to a user. According to one embodiment, the Cluster CLI (CCLI) is invoked during a telnet or SecureShell session with one of the members of the cluster. CCLI applies a configuration lock on all devices of the cluster immediately after being invoked and presents a prompt and awaits commands.

According to one embodiment, CCLI 225 is implemented as a ‘shell’ application. According to one embodiment of the invention, the CCLI application resides on all members of the cluster so that it is available regardless of which member is accessed by telnet or SecureShell.

The GUI and the CLI can present the NM information in several ways. For example, statistics for IP packet traffic can be displayed either as an aggregate of all nodes using aggregator 230 or on a per-node basis.

When an operation is issued to display monitored data or NM attributes, CGUI 220 or CCLI 225 interacts with Remote Management Broker 245 to collect the attributes from the Configuration Subsystems and Aggregator 230 performs the aggregation and display the results using the CGUI and CCLI.

When an operation is issued to alter NM attributes, CGUI 220 or CCLI 225 interacts with Remote Management Broker 245 to apply the changes to all of the nodes within the cluster. According to one embodiment, when the change cannot be applied to a member, RMB 245 restores the original value of the attribute to all of the members where the altered attribute was successfully applied. This helps to ensure that all of the members maintain the same values. When a problem occurs RMB 245 indicates that there was a failure to the CGUI and CCLI. When the NM operations are completed the user exits the CGUI or CCLI and the configuration lock is released.

The configuration lock may be implemented either entirely within the Remote Management Broker, as a part of the Configuration Subsystem, or as a completely separate subsystem. According to one embodiment, the configuration lock is a part of the Configuration Subsystem. This helps to ensure that the configuration lock is uniformly enforced while still allowing non-conflicting activities to occur. For example, the Configuration Subsystem might allow attribute retrieval without regard to the state of the configuration lock.

Instead of requiring a user to have multiple GUIs or CLIs open to configure the cluster, a single GUI or CLI may be used for the configuration.

Aggregator 230 performs the algorithms to combine NM information from the devices within the cluster. For example, aggregator 230 normalizes the data with timestamps. Aggregator 230 may also remove identifying characteristics of the nodes within the cluster to better present operation of the cluster as an entirety. Aggregator 230 allows the NM monitored data to be aggregated without the Aggregator itself having to download the data from each node individually, thereby saving time.

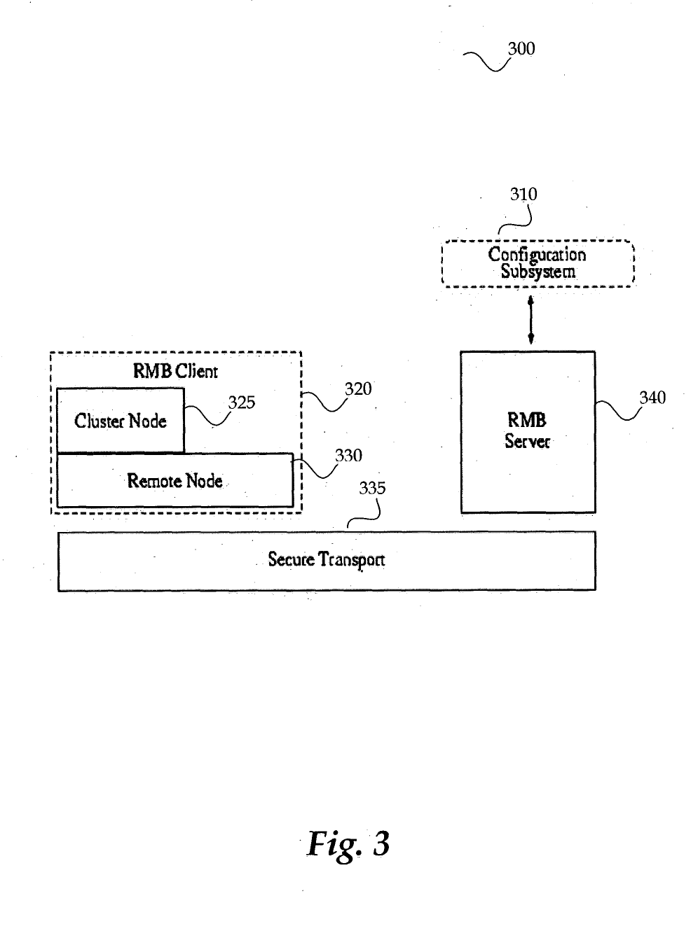

FIG. 3 illustrates components of the Remote Management Broker, in accordance with aspects of the invention. As illustrated in the figure, RMB 300 includes RMB Client 320, configuration subsystem 310, RMB Server 340 and secure transport 335. RMB Client 320 includes cluster node 325 and remote node 330. Cluster Node 325 maintains information about the cluster's members. Remote Node 330 maintains information about each cluster member and tracks NM operations. Secure Transport 335 delivers and receives messages to perform NM operations and performs integrity checks on the messages. RMB Server 340 is arranged to communicate with configuration subsystem 310 and communicate with RMB client 320 through secure transport 335.

Remote Management Broker 300 acts as the backbone for the nodes within the cluster. RMB 300 provides base mechanisms including: discovering the members within the cluster; delivering queries and operations relating to NM attributes to the devices in the cluster; ensuring message integrity; an interface fo r management applications; and an interface to each device's local configuration subsystem. RMB 300 also includes a secure mechanism for transporting the information in the messages sent between the nodes within the cluster.

Remote Management Broker 300 helps to maintain identical configurations of Network Management features on all devices in the cluster. Since RMB 245 is coupled to all of the nodes within the cluster there is less chance for an error in configuration of the devices.

RMB 300 is also configured to automatically query the nodes it is coupled with in order to determine the cluster members. These queries are performed periodically to help ensure that all cluster members are available at any given time.

According to one embodiment, RMB 300 ensures consistency of the configuration by using database transactions. For example to begin a transaction whenever an attribute is to be changed and applying a ‘commit’ database operation if the change is successful on all devices and a ‘rollback’ operation when the change fails on any device. The RMB may implement these transactions either internally or by using the transaction capabilities of the Configuration Subsystem. According to one embodiment, the Configuration Subsystem's transactions are used since these may be complicated operations.

RMB Client 320 uses Cluster Node 325 to discover the cluster's member devices.

RMB 300 uses messages to perform system and NM operations. The system operations include acquiring and releasing the configuration lock. When a message is to be sent, the RMB fills in the message header and delivers the message. When a message is received, the RMB checks the header and accepts the message only if values in the fields of the header are valid. The RMB discards any message whose header has invalid values in the fields.

RMB Client 320 composes the body of an RMB message and uses Cluster Node 325 to deliver the message to each of the cluster members; receive the responses from the members; and extract the result of the operation from the message. In the case of NM attribute or monitored data retrieval, Cluster Node 325 extracts the data from the message and returns it to the CGUI or CCLI. Remote Node 330 delivers the message to a particular cluster member and checks that a response message is received for every request message sent. Secure Transport 335 is the transport mechanism that actually sends and receives the messages.

The RMB Client can be implemented as a collection of shared-object libraries with well-defined Application Programming Interfaces (APIs). CGUI and CCLI can use these APIs to interact with the RMB to perform NM operations.

The RMB Server can be implemented as a daemon that is launched during system start-up.

RMB's Secure Transport can be implemented as a Secure Sockets Layer (SSL) socket. This provides an extra layer of security by providing the ability to encrypt the RMB messages.

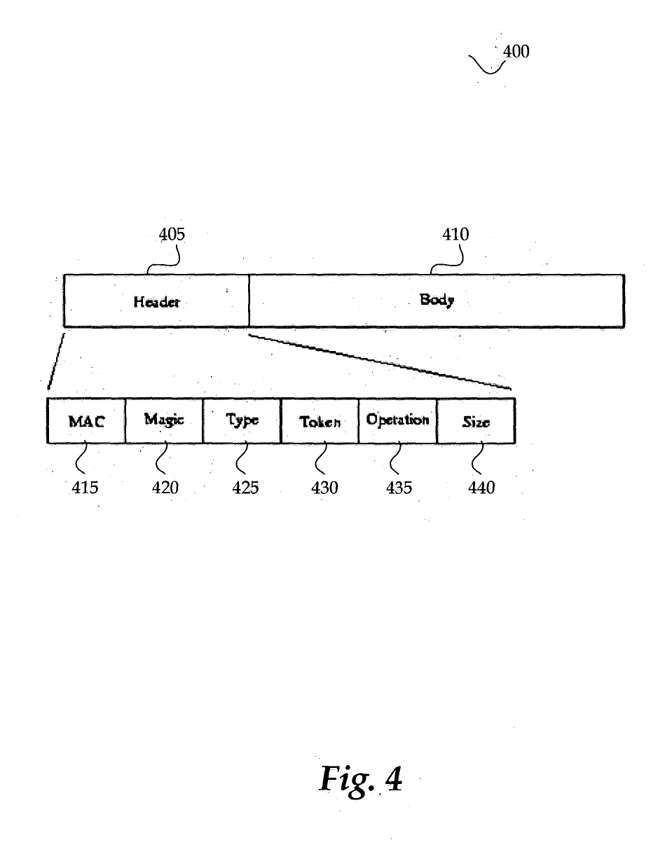

FIG. 4 shows an exemplary Remote Management Broker message, in accordance with aspects of the invention. Message 400 includes header 405 and body 410. According to one embodiment of the invention, header 405 is identical for all messages, and body 410 is dependent on the type of message being sent. The header comprises the following fields:

Message Authentication Code (MAC) 415 is calculated from the message's contents and a value that is provided to all members the system. The value acts as a “shared secret” between the members of the cluster.

Magic value 420 is identical for all messages and indicates that the message is an RMB message.

Type value 425 indicates the type of message. According to one embodiment of the invention, the message type includes a ‘request’ type and a ‘response’ type.

Token value 430 is unique for each request/response message and can be used by the RMB Client to track outstanding requests.

Operation 435 indicates the particular NM operation to be performed at each cluster member. According to one embodiment of the invention, the operations include an ‘attribute get’ operation and an ‘attribute set’ option.

Size value 440 contains the number of bytes in the message's body.

The MAC and Magic fields ensure the integrity of the message. MAC 415 ensures the integrity for the contents of the message (including the header). MAGIC field 420 ensures the integrity of the origin of the message (an RMB Client or Server).

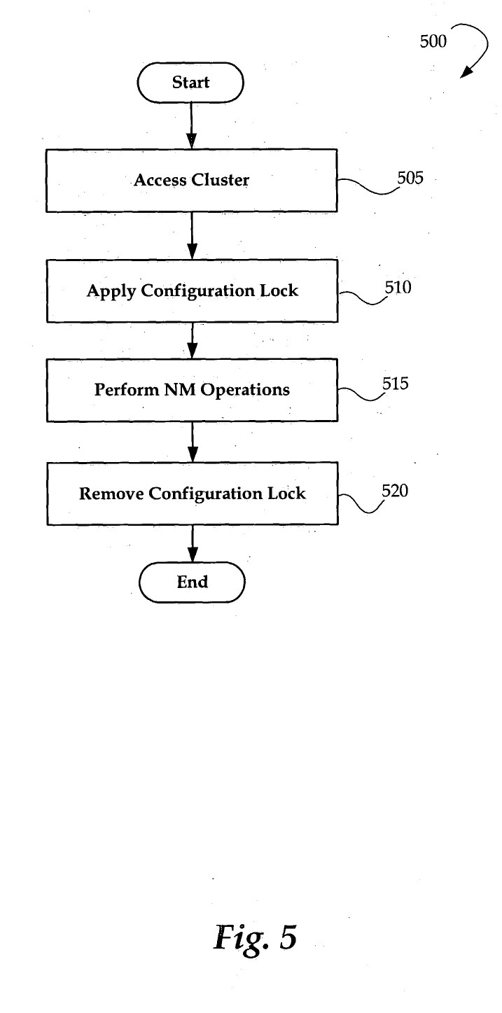

FIG. 5 illustrates a process flow for utilizing a cluster management system, in accordance with aspects of the invention. After a start block, process 500 flows to block 505 where the cluster is accessed. According to one embodiment of the invention, any device within the cluster may be used to access the cluster. Additionally, a device outside of the cluster may also be used.

Transitioning to block 510 a configuration lock is applied to the devices within the cluster. As discussed above, the configuration lock is used to help prevent other users from making changes to the devices within the cluster while another user is making changes.

Flowing to block 515, the NM operation is performed. The NM operation may be a request to set a parameter or a request to obtain information relating to the nodes within the cluster.

Moving to block 520, the configuration lock is removed after all of the NM operations have been performed that were requested. The process then moves to an end block and returns to processing other actions.

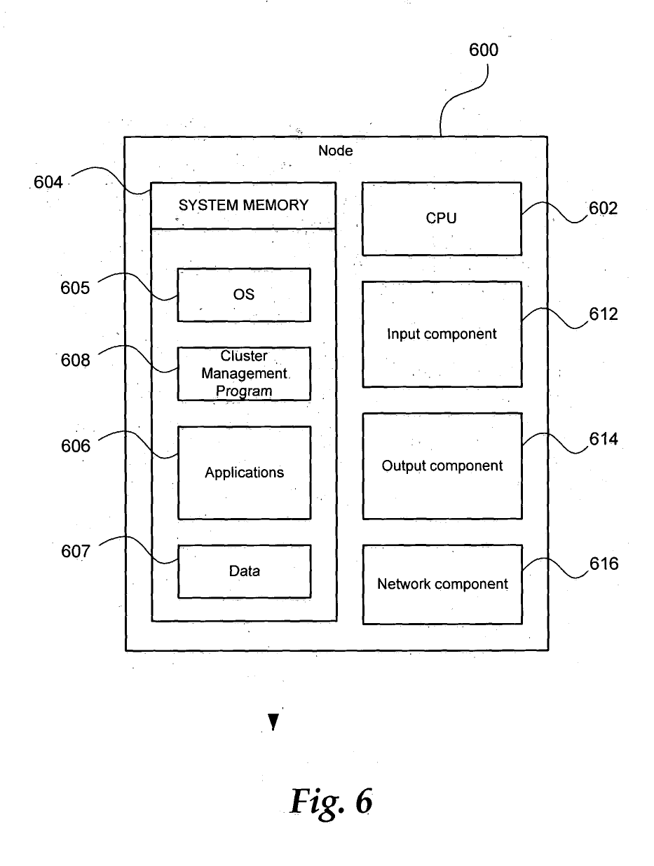

FIG. 6 illustrates an exemplary computing device that may be used in accordance with aspects of the invention. For illustrative purposes, node 600 is only shown with a subset of the components that are commonly found in a computing device. A computing device that is capable of working in this invention may have more, less, or different components as those shown in FIG. 6. Node 600 may include various hardware components. In a very basic configuration, Node 600 typically includes central processing unit 602, system memory 604, and network component 616.

Depending on the exact configuration and type of computing device, system memory 0.604 may include volatile memory, non-volatile memory, data storage devices, or the like. These examples of system memory 604 are all considered computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by node 600. Any such computer storage media may be part of node 600.

Node 600 may include input component 612 for receiving input. Input component 612 may include a keyboard, a touch screen, a mouse, or other input devices. Output component 614 may include a display, speakers, printer, and the like.

Node 600 may also includes network component 616 for communicating with other devices in an IP network. In particular, network component 616 enables node 600 to communicate with mobile nodes and corresponding nodes. Node 600 may be configured to use network component 616 to receive and send packets to and from the corresponding nodes and the mobile nodes. The communication may be wired or wireless.

Signals sent and received by network component 616 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Software components of node 600 are typically stored in system memory 604. System memory 604 typically includes an operating system 605, one or more applications 606, and data 607. As shown in the figure, system memory 604 may also include cluster management program 608. Program 608 is a component for performing operations for cluster management as described above. Program 608 includes computer-executable instructions for performing processes relating to cluster management.

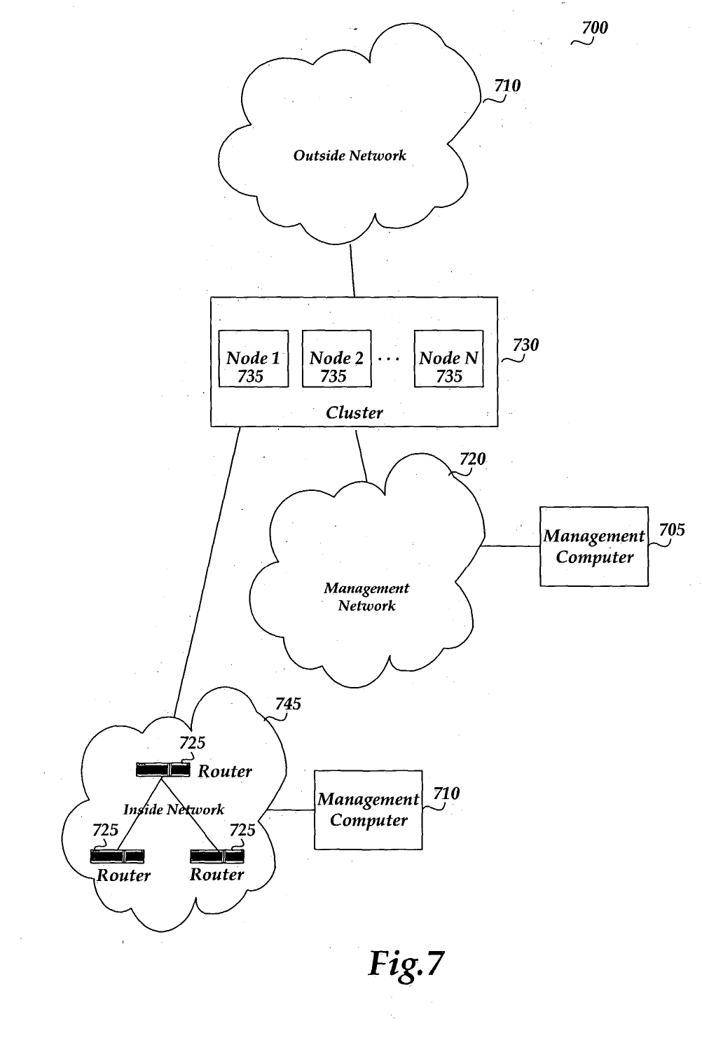

With reference to FIG. 7, an exemplary IP network in which the invention may operate is illustrated. As shown in the figure, IP network 700 includes management computers 705 and 710, cluster 730, outside network 710, management network 720, routers 725, and inside network 745. Cluster 730 includes nodes 735 that are arranged to act as a single node. The networks may be wired or wireless networks that are coupled to wired or wireless devices.

As illustrated, inside network 745 is an IP packet based backbone network that includes routers, such as routers 725 to connect the support nodes in the network. Routers are intermediary devices on a communications network that expedite message delivery. On a single network linking many computers through a mesh of possible connections, a router receives transmitted messages and forwards them to their correct destinations over available routes. On an interconnected set of LANs, including those based on differing architectures and protocols, a router acts as a link between LANs, enabling messages to be sent from one to another. Communication links within LANs typically include twisted wire pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links.

Management computer 705 is coupled to management network 720 through communication mediums. Management computer 710 is coupled to inside network 745 through communication mediums. Management computers 705 and 710 may be used to manage a cluster, such as cluster 730.

Furthermore, computers, and other related electronic devices may be connected to network 710, network 720, and network 745. The public Internet itself may be formed from a vast number of such interconnected networks, computers, and routers. IP network 700 may include many more components than those shown in FIG. 7. However, the components shown are sufficient to disclose an illustrative embodiment for practicing the present invention.

The media used to transmit information in the communication links as described above illustrates one type of computer-readable media, namely communication media. Generally, computer-readable media includes any media that can be accessed by a computing device. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

The above specification, examples and data provide a complete description of the invention. Since many embodiments of the invention can be made without departing from the spirit and scope of the invention, the invention resides in the claims hereinafter appended.

What is claimed is:

1. A system for cluster management that allows the configuration and monitoring of a cluster from a single-point, comprising:
a network interface configured to communicate with nodes in the cluster;
a memory configured to store information relating to cluster management;
a configuration subsystem coupled to a remote management broker, wherein the remote management broker is configured to distribute information between the nodes in the cluster;
a processor configured to perform actions, including:
accessing the cluster from the single-point;
obtaining information relating to devices within the cluster;
presenting the information to a user; and
determining network management (NM) operations to perform to the cluster; and
performing the determined NM operations.

2. The system of claim 1, wherein presenting the information to the user, further comprises a command line interface configured to access the cluster.

3. The system of claim 1, wherein presenting the information to the user, further comprises a graphical user interface configured to access the cluster.

4. The system of claim 1, further comprising an aggregator configured to aggregate data relating to the devices within the cluster.

5. The system of claim 1, wherein the RMB further comprises:
a secure transport configured to transport messages;
an RMB server coupled to the secure transport; and
an RMB client coupled to the secure transport.

6. The system of claim 1, wherein the RMB is further configured to collect attributes from the Configuration Subsystem.

7. The system of claim 1, wherein the messages include a header which is configured to authenticate the messages.

8. The system of claim 7, wherein the header includes a message authentication code that acts as a shared secret within the cluster and a magic field that identifies the message as a remote management broker message.

9. A method for providing cluster management that allows the configuration and monitoring of a cluster from a single-point, comprising:
accessing the cluster from the single-point;
obtaining attributes relating to devices within the cluster;
receiving input from a user relating to the attributes;
determining network management (NM) operations to perform on the cluster based on the received input; and
performing the determined NM operations on the cluster.

10. The method of claim 9, further comprising applying a configuration lock that is intended to prevent other applications from performing NM operations on the devices within the cluster.

11. The method of claim 9, wherein the single-point is selected from a command line interface and a graphical user interface.

12. The method of claim 11, further comprising distributing information between the nodes in the cluster using a remote management broker.

13. The method of claim 12, wherein performing the determined NM operations on the cluster further comprise distributing the NM operations to each of the devices.

14. The method of claim 12, further comprising determining if the operations on the cluster were performed correctly, and if not, rolling back to a successful configuration.

15. The method of claim 12, further comprising utilizing a header which is configured to authenticate the messages.

16. The method of claim 9, further comprising releasing the configuration lock after the NM operations are performed.

17. The method of claim 9, further comprising aggregating data relating to the devices within the cluster on a single device within the cluster.

18. A computer readable medium for cluster management, comprising:
obtaining attributes relating to devices within a cluster from a single-point;
receiving input relating to the attributes;
determining network management (NM) operations to perform on the cluster based on the received input;
distributing the NM operations to the devices within the cluster; and
applying the NM operations.

19. The computer readable medium of claim 18, further comprising applying a configuration lock that is intended to prevent other applications from performing NM operations on the devices within the cluster during a predetermined time.

20. The computer readable medium of claim 18, wherein receiving the input further comprises utilizing a command line interface and a graphical user interface.

21. The computer readable medium of claim. 18, further comprising determining if the operations on the cluster were applied correctly, and if not, rolling back to a successful configuration.

22. The computer readable medium of claim 18, further comprising providing a header which is configured to help in authenticating the messages.

23. The computer readable medium of claim 18, further comprising aggregating data relating to the devices within the cluster on a single device within the cluster.

24. An apparatus for cluster management, comprising:
means for obtaining attributes relating to devices within a cluster from a single-point;
means for receiving input relating to the attributes;
means for determining network management (NM) operations to perform on the cluster based on the received input;
means for distributing the NM operations to the devices within the cluster; and
means for applying the NM operations to the devices within the cluster.

25. The apparatus of claim 24, further comprising means for applying a configuration lock that is intended to prevent other applications from performing NM operations on the devices within the cluster during a predetermined time.

26. The apparatus of claim 24, further comprising means for determining if the operations on the cluster were applied correctly, and if not, rolling back to a successful configuration.
